(19) United States
(12) Patent Application Publication
(10) Pub. No.: US 2021/0319690 A1
(43) Pub. Date: Oct. 14, 2021

(54) INFORMATION PROVIDING DEVICE, INFORMATION PROVIDING METHOD, INFORMATION PROVIDING SYSTEM, COMPUTER PROGRAM, AND DATA STRUCTURE

(71) Applicant: Sumitomo Electric Industries, Ltd., Osaka-shi (JP)

(72) Inventors: Akihiro OGAWA, Osaka-shi (JP); Katsunori USHIDA, Osaka-shi (JP); Koichi TAKAYAMA, Osaka-shi (JP)

(73) Assignee: Sumitomo Electric Industries, Ltd., Osaka-shi (JP)

(21) Appl. No.: 17/269,894

(22) PCT Filed: Jul. 16, 2019
(86) PCT No.: PCT/JP2019/027933

§ 371 Date: Feb. 19, 2021

(30) Foreign Application Priority Data
Aug. 24, 2018 (JP) 2018-157239

(51) Int. Cl. G08G 1/01; G08G 1/017; G08G 1/056; G08G 1/0962

(52) U.S. Cl. CPC G08G 1/0112; G08G 1/0125; G08G 1/0962; G08G 1/056; G08G 1/017

(57) ABSTRACT

An information providing device includes: a selection unit configured to, according to a positional relationship between a first dynamic object and one or a plurality of second dynamic objects that receive information regarding the first dynamic object, select a hierarchical layer from an analysis result in which sensor information regarding the first dynamic object is hierarchized into a plurality of hierarchical layers; and an output unit configured to output information of the hierarchical layer selected by the selection unit.

### TECHNICAL FIELD

The present invention relates to an information providing device, an information providing method, an information providing system, a computer program, and a data structure.

This application claims priority on Japanese Patent Application No. 2018-157239 filed on Aug. 24, 2018, the entire content of which is incorporated herein by reference.

### BACKGROUND ART

A system, in which sensor information from a fixedly installed sensor (hereinafter also referred to as “infrastructure sensor”) such as a street monitoring camera is uploaded to a server computer (hereinafter referred to simply as “server”), analyzed, and monitored, has been proposed. Meanwhile, it has been proposed to mount various types of sensors on automobiles, motorcycles, etc. (hereinafter referred to as “vehicles”), upload sensor information from these sensors to a server to analyze the sensor information, and use the sensor information for driving support.

A sensor mounted on a vehicle (hereinafter also referred to as “on-vehicle sensor) can acquire information about a road on which the vehicle is traveling, but cannot acquire information regarding a road intersecting the road on which the vehicle is traveling because the information is blocked by buildings, etc., in the vicinity of the road, which may cause a dead angle region near an intersection, for example. In order to avoid this, it is preferable to use, for driving support, both the analysis result of the sensor information from the on-vehicle sensor and the analysis result of the sensor information from the fixedly installed sensor such as a street monitoring camera.

For example, PATENT LITERATURE 1 discloses a wireless communication system including: a plurality of communication terminals capable of wireless communication; one or a plurality of base stations wirelessly communicating with the communication terminals; one or a plurality of edge servers communicating with the base stations wirelessly or via wires; and one or a plurality of core servers communicating with the edge servers wirelessly or via wires. The communication terminals include a communication terminal of a vehicle, a communication terminal of a pedestrian, a communication terminal of a roadside sensor, and a communication terminal of a traffic signal controller. The respective elements constituting the wireless communication system are classified into a plurality of network slices S1 to S4 according to predetermined service requirements such as a delay time. In the slice S1, the plurality of communication terminals directly communicate with each other. In the slice S2, the plurality of communication terminals communicate with a base station 2. In the slice S3, the plurality of communication terminals communicate with an edge server 3 via the base station 2. In the slice S4, the plurality of communication terminals communicate with a core server 4 via the base station 2 and the edge server 3. The wireless communication system thus constituted can appropriately provide information to a target vehicle.

### CITATION LIST

### Patent Literature

PATENT LITERATURE 1: Japanese Laid-Open Patent Publication No. 2018-18284

### SUMMARY OF INVENTION

An information providing device according to one aspect of the present disclosure includes: a selection unit configured to, according to a positional relationship between a first dynamic object and one or a plurality of second dynamic objects that receive information regarding the first dynamic object, select a hierarchical layer from an analysis result in which sensor information regarding the first dynamic object is hierarchized into a plurality of hierarchical layers; and an output unit configured to output information of the hierarchical layer selected by the selection unit.

An information providing method according to one aspect of the present disclosure includes: analyzing sensor information to detect a first dynamic object, and generating an analysis result in which the sensor information regarding the first dynamic object is hierarchized into a plurality of hierarchical layers; specifying a positional relationship between the first dynamic object and one or a plurality of second dynamic objects that receive information regarding the first dynamic object; selecting a hierarchical layer from among the plurality of hierarchical layers according to the positional relationship; and outputting information of the selected hierarchical layer.

A computer program according to one aspect of the present disclosure causes a computer to realize: a function of analyzing sensor information to detect a first dynamic object, and generating an analysis result in which the sensor information regarding the first dynamic object is hierarchized into a plurality of hierarchical layers; a function of specifying a positional relationship between the first dynamic object and one or a plurality of second dynamic objects that receive information regarding the first dynamic object; a function of selecting a hierarchical layer from among the plurality of hierarchical layers according to the positional relationship; and a function of outputting information of the selected hierarchical layer.

An information providing system according to one aspect of the present disclosure includes: a server computer including a reception unit configured to receive sensor information, and an analysis unit configured to analyze the sensor information received by the reception unit to detect a first dynamic object, and generate an analysis result in which the sensor information regarding the first dynamic object is hierarchized into a plurality of hierarchical layers; and a communication device possessed by one or a plurality of second dynamic objects that receive information regarding the first dynamic object. The server computer further includes: a specification unit configured to specify a positional relationship between the first dynamic object and the second dynamic object; a selection unit configured to select a hierarchical layer from among the plurality of hierarchical layers according to the positional relationship; and a transmission unit configured to transmit information of the selected hierarchical layer to the communication device.

An information providing system according to one aspect of the present disclosure includes: a server computer including a reception unit configured to receive sensor information, and an analysis unit configured to analyze the sensor information received by the reception unit to detect a first dynamic object, and generate an analysis result in which the sensor information regarding the first dynamic object is hierarchized into a plurality of hierarchical layers; and a communication device possessed by one or a plurality of second dynamic objects that receive information regarding the first dynamic object. The server computer further includes a transmission unit configured to transmit information of the plurality of hierarchical layers to the second dynamic object. The communication device of the second dynamic object includes: a reception unit configured to receive the information of the plurality of hierarchical layers transmitted from the server computer; a specification unit configured to specify a positional relationship between the first dynamic object and the second dynamic object; a selection unit configured to select a hierarchical layer from among the plurality of hierarchical layers according to the positional relationship; and an output unit configured to output information of the selected hierarchical layer.

A data structure according to another aspect of the present disclosure is a data structure hierarchized into a plurality of hierarchical layers regarding a dynamic object detected by analyzing sensor information. The plurality of hierarchical layers include: a first hierarchical layer including information regarding a current position of the dynamic object; a second hierarchical layer including information regarding a current attribute of the dynamic object; a third hierarchical layer including information regarding a current action pattern of the dynamic object; and a fourth hierarchical layer including information regarding at least one of a position, an attribute, and an action pattern of the dynamic object after a predetermined time.

The present disclosure can be implemented as an information providing device including such characterized processing units, an information providing method having steps of such characterized processes, and a computer program for causing a computer to execute the characteristic processes. Meanwhile, the present disclosure can be implemented as a semiconductor integrated circuit having a function of executing some or all of the steps, a data structure used for the computer program, and an information providing system including the information providing device.

### BRIEF DESCRIPTION OF DRAWINGS

FIG. 1 is a schematic diagram showing a configuration of an information providing system according to an embodiment of the present disclosure.

FIG. 2 is a plan view showing an intersection and its vicinity in a monitoring target area of the information providing system according to the embodiment of the present disclosure.

FIG. 3 is a block diagram showing a configuration of a server.

FIG. 4 is a block diagram showing a configuration of an on-vehicle device.

FIG. 5 is a block diagram showing a configuration of an infrastructure sensor.

FIG. 6 is a block diagram showing a function of the server.

FIG. 7 is a schematic diagram showing a relationship between the types (hierarchical layers) of driving support information and delay times.

FIG. 8 is a schematic diagram showing that different types of driving support information are provided according to a distance between a detected object and each of on-vehicle devices.

FIG. 9 is a flowchart showing server processing.

FIG. 10 is a schematic diagram showing a situation where the type of driving support information provided to an on-vehicle device of one vehicle varies according to a distance between the vehicle and a detected object.

FIG. 11 is a plan view showing a situation in which information provided by the on-vehicle device varies.

FIG. 12A illustrates an example of information provided to the on-vehicle device.

FIG. 12B illustrates an example of information provided to the on-vehicle device, which follows FIG. 12A.

FIG. 13A illustrates an example of information provided to the on-vehicle device, which follows FIG. 12B.

FIG. 13B illustrates an example of information provided to the on-vehicle device, which follows FIG. 13A.

### DESCRIPTION OF EMBODIMENTS

### Problems to be Solved by the Present Disclosure

Various types of sensors are used as on-vehicle sensors and infrastructure sensors. Representative sensors are, for example, laser sensors (LiDAR, etc.), millimeter-wave radars, and image sensors (camera, etc.). The type of sensor information acquired by a sensor, the form of data outputted from the sensor, and the amount of outputted data vary from sensor to sensor. Therefore, the time required for analyzing the sensor information also varies. That is, a time period (delay time) from when sensor information is acquired by a sensor to when the sensor information is received and analyzed by an analysis device (e.g., a server) and the analysis result is transmitted and received by an on-vehicle device, depends on the type of analysis. Meanwhile, various forms are considered regarding driving support information formed by analyzing the sensor information. Therefore, it is preferable to appropriately transmit the analysis result as driving support information, according to the sensor information, the type of analysis, etc.

Meanwhile, if driving support information is uniformly transmitted to the on-vehicle devices of the respective vehicles, data communication traffic increases, which may cause congestion. Furthermore, an inefficient situation where some vehicles receive information that cannot be used for driving support may occur.

### Effects of the Present Disclosure

According to the present disclosure, in providing driving support information to on-vehicle devices, etc., the driving support information can be appropriately provided, whereby increase in traffic of data communication can be inhibited.

### <Outline of Embodiment of the Present Disclosure>

Hereinafter, the outline of an embodiment of the present disclosure is listed and described.

(1) An information providing device according to the embodiment includes: a selection unit configured to, according to a positional relationship between a first dynamic object and one or a plurality of second dynamic objects that receive information regarding the first dynamic object, select a hierarchical layer from an analysis result in which sensor information regarding the first dynamic object is hierarchized into a plurality of hierarchical layers; and an output unit configured to output information of the hierarchical layer selected by the selection unit. Therefore, in providing the driving support information to the second dynamic objects such as on-vehicle devices, the driving support information can be appropriately provided.

(2) In the information providing device according to the embodiment, the analysis result may be hierarchized in an ascending order of a delay time including a time from when the sensor information is transmitted from a sensor to when the sensor information is received by an analysis device, and a time during which the received sensor information is analyzed by the analysis device. Therefore, in providing the driving support information to the second dynamic objects such as on-vehicle devices, increase in traffic of data communication can be inhibited.

(3) In the information providing device according to the embodiment, the hierarchical layer may include at least one of position information, an attribute, an action, and action prediction of the first dynamic object. Therefore, in providing the driving support information to the second dynamic objects such as on-vehicle devices, the driving support information can be provided more appropriately.

(4) In the information providing device according to the embodiment, the selection unit may select at least two hierarchical layers from among the plurality of hierarchical layers, and the output unit may output information of the selected hierarchical layers at the same timing to the second dynamic objects. Therefore, in providing the driving support information to the second dynamic objects such as on-vehicle devices, the hierarchical layers of the information can be appropriately selected on the second dynamic object side.

(5) In the information providing device according to the embodiment, the selection unit may select at least two hierarchical layers from among the plurality of hierarchical layers, and the output unit may output information of the selected hierarchical layers at different timings to the second dynamic objects. Therefore, in providing the driving support information to the second dynamic objects such as on-vehicle devices, increase in traffic of data communication can be further inhibited.

(6) The information providing device according to the embodiment may further include a determination unit configured to determine the positional relationship between the first dynamic object and the second dynamic object, according to at least one of heading, speed, acceleration, and destination of the second dynamic object. Therefore, in providing the driving support information to the second dynamic objects such as on-vehicle devices, a second dynamic object to be provided with the driving support information can be appropriately determined.

(7) In the information providing device according to the embodiment, the positional relationship may be a distance between the first dynamic object and the second dynamic object. Therefore, in providing the driving support information to the second dynamic objects such as on-vehicle devices, a second dynamic object to be provided with the driving support information can be easily determined.

(8) In the information providing device according to the embodiment, the output unit may output, to the second dynamic objects, information of the hierarchical layers, and update information indicating whether or not the information of the hierarchical layers has been updated. Therefore, management of the driving support information in the second dynamic object is facilitated.

(9) In the information providing device according to the embodiment, there are a plurality of second dynamic objects, the plurality of second dynamic objects are grouped according to a current position of each of the second dynamic objects, and the output unit may output information of the same hierarchical layer to the second dynamic objects in the same group. Therefore, in providing the driving support information to the second dynamic objects such as on-vehicle devices, the driving support information can be easily provided.

(10) An information providing method according to the embodiment includes: analyzing sensor information to detect a first dynamic object, and generating an analysis result in which the sensor information regarding the first dynamic object is hierarchized into a plurality of hierarchical layers; specifying a positional relationship between the first dynamic object and one or a plurality of second dynamic objects that receive information regarding the first dynamic object; selecting a hierarchical layer from among the plurality of hierarchical layers according to the positional relationship; and outputting information of the selected hierarchical layer. Therefore, in providing the driving support information to the second dynamic objects such as on-vehicle devices, the driving support information can be appropriately provided.

(11) A computer program according to the embodiment causes a computer to realize: a function of analyzing sensor information to detect a first dynamic object, and generating an analysis result in which the sensor information regarding the first dynamic object is hierarchized into a plurality of hierarchical layers; a function of specifying a positional relationship between the first dynamic object and one or a plurality of second dynamic objects that receive information regarding the first dynamic object; a function of selecting a hierarchical layer from among the plurality of hierarchical layers according to the positional relationship; and a function of outputting information of the selected hierarchical layer. Therefore, in providing the driving support information to the second dynamic objects such as on-vehicle devices, the driving support information can be appropriately provided.

(12) An information providing system according to the embodiment includes: a server computer including a reception unit configured to receive sensor information, and an analysis unit configured to analyze the sensor information received by the reception unit to detect a first dynamic object, and generate an analysis result in which the sensor information regarding the first dynamic object is hierarchized into a plurality of hierarchical layers; and a communication device possessed by one or a plurality of second dynamic objects that receive information regarding the first dynamic object. The server computer further includes: a specification unit configured to specify a positional relationship between the first dynamic object and the second dynamic object; a selection unit configured to select a hierarchical layer from among the plurality of hierarchical layers according to the positional relationship; and a transmission unit configured to transmit information of the selected hierarchical layer to the communication device. Therefore, in providing the driving support information to the second dynamic objects such as on-vehicle devices, the driving support information can be appropriately provided.

(13) An information providing system according to the embodiment includes: a server computer including a reception unit configured to receive sensor information, and an analysis unit configured to analyze the sensor information received by the reception unit to detect a first dynamic object, and generate an analysis result in which the sensor information regarding the first dynamic object is hierarchized into a plurality of hierarchical layers; and a communication device possessed by one or a plurality of second dynamic objects that receive information regarding the first dynamic object. The server computer further includes a transmission unit configured to transmit information of the plurality of hierarchical layers to the second dynamic object. The communication device of the second dynamic object includes: a reception unit configured to receive the information of the plurality of hierarchical layers transmitted from the server computer; a specification unit configured to specify a positional relationship between the first dynamic object and the second dynamic object; a selection unit configured to select a hierarchical layer from among the plurality of hierarchical layers according to the positional relationship; and an output unit configured to output information of the selected hierarchical layer. Therefore, the driving support information can be appropriately provided from an on-vehicle device or the like mounted on the second dynamic object.

(14) A data structure according to the embodiment is a data structure hierarchized into a plurality of hierarchical layers regarding a dynamic object detected by analyzing sensor information. The plurality of hierarchical layers include: a first hierarchical layer including information regarding a current position of the dynamic object; a second hierarchical layer including information regarding a current attribute of the dynamic object; a third hierarchical layer including information regarding a current action pattern of the dynamic object; and a fourth hierarchical layer including information regarding at least one of a position, an attribute, and an action pattern of the dynamic object after a predetermined time. Therefore, the driving support information can be appropriately provided to an on-vehicle device or the like.

### <Details of Embodiment of the Present Disclosure>

Hereinafter, an embodiment of the present disclosure will be described with reference to the drawings. At least some parts of the embodiment described below may be combined together as desired. In the following description, the same reference numerals refer to the same components and constituent elements. The names and functions thereof are also the same. Therefore, repeated description thereof is not necessary.

### Embodiment

### [Overall Configuration]

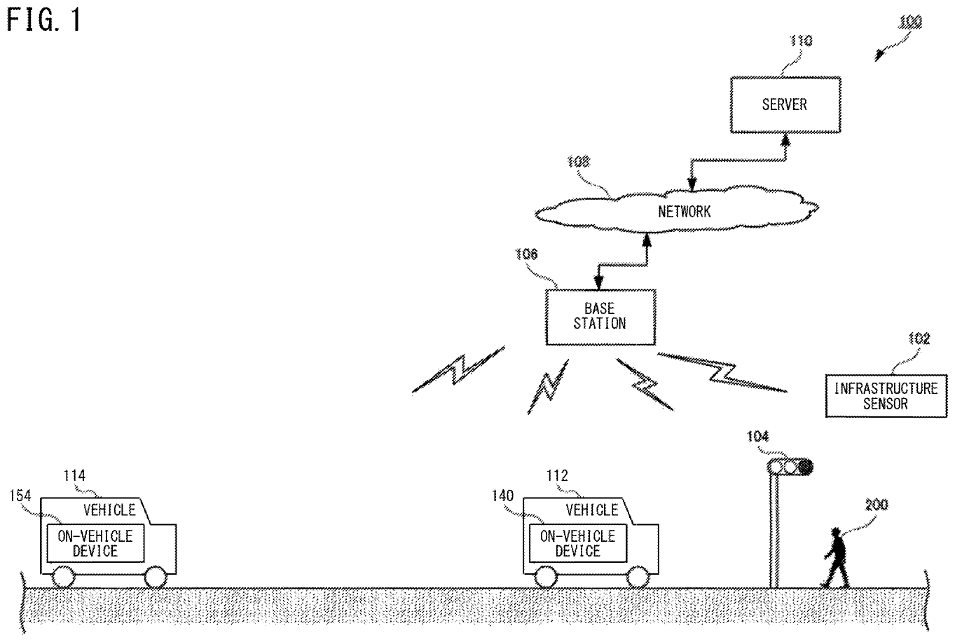

With reference to FIG. 1, an information providing system 100 according to an embodiment of the present disclosure includes: an infrastructure sensor 102 fixedly installed on a road and its periphery (hereinafter also referred to as “on a road”); a road traffic signal unit 104; a base station 106 for wireless communication; a server 110 communicating with the base station 106 via a network 108; and a plurality of vehicles 112 and 114. The vehicle 112 and the vehicle 114 are equipped with an on-vehicle device 140 and an on-vehicle device 154, respectively. A pedestrian 200 is an object to be detected by the infrastructure sensor 102. In this embodiment, communication between the elements constituting the information providing system 100 is performed via the base station 106 for mobile communication. The base station 106 provides mobile communication services using, for example, a 5G (5th-generation mobile communication system) line or the like.

The infrastructure sensor 102 is a device that is installed on a road and its periphery, and has a function of acquiring information about the road and its periphery. The infrastructure sensor 102 has a function of communicating with the base station 106. The infrastructure sensor 102 is, for example, an image sensor (e.g., digital monitoring camera), a radar (e.g., millimeter-wave radar), a laser sensor (e.g., LiDAR), or the like.

The server 110 receives information (hereinafter also referred to as “sensor information”) uploaded from the infrastructure sensor 102 via the base station 106, analyzes the information, generates information for driving support, and transmits the information to the vehicle 112 and the vehicle 114. In addition, the server 110 also receives information, which is uploaded from the traffic signal unit 104 via the base station 106 and indicates the state of the traffic signal unit 104 (e.g., information indicating color in a steadily lighting state or blinking state; hereinafter referred to as “traffic information”), and uses the information for generation of information for driving support.

The on-vehicle device 140 and the on-vehicle device 154 respectively mounted on the vehicle 112 and the vehicle 114 have a communication function according to a communication specification (here, 5G line) that the base station 106 services.

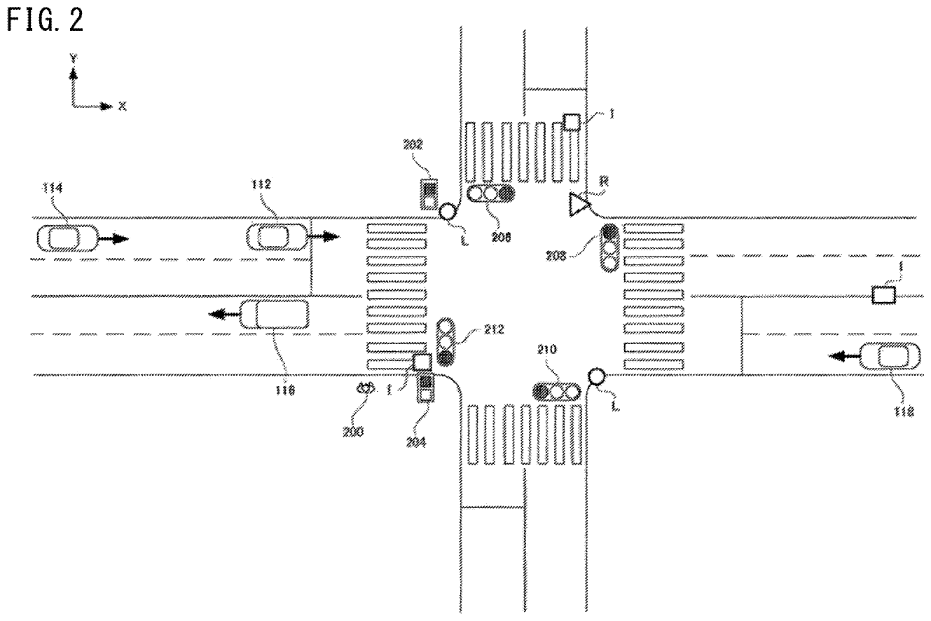

FIG. 1 exemplifies one base station 106, one infrastructure sensor 102, one traffic signal unit 104, and two vehicles 112 and 114 having different distances from the pedestrian 200. However, usually, a plurality of base stations are installed and three or more vehicles are provided with mobile communication functions. Two or more infrastructure sensors may be installed in a predetermined area such as an intersection. For example, with reference to FIG. 2, a plurality of traffic signal units such as traffic signal units 202 and 204 for pedestrians (other traffic signal units for pedestrians are not shown) and traffic signal units 206 to 212 for vehicles, a plurality of image sensors I, a plurality of sensors L, and one radar R, are installed at an intersection. In FIG. 2, the traffic signal units 202 and 204 for pedestrians and the traffic signal units 206 and 210 for vehicles are red, the traffic signal units 208 and 212 for vehicles are green, the pedestrian 200 is stopped, and the vehicles 112, 114, 116, and 118 are traveling. As described later, the vehicles 112 and 114 are also equipped with a plurality of on-vehicle sensors, and the on-vehicle devices 140 and 154 transmit information from the on-vehicle sensors to the server 110 via the base station 106. The server 110 communicates with the infrastructure sensors, the on-vehicle devices of the vehicles, and the traffic signal units, collects and analyzes information, and provides driving support information to the on-vehicle devices.

### [Hardware Configuration of Server]

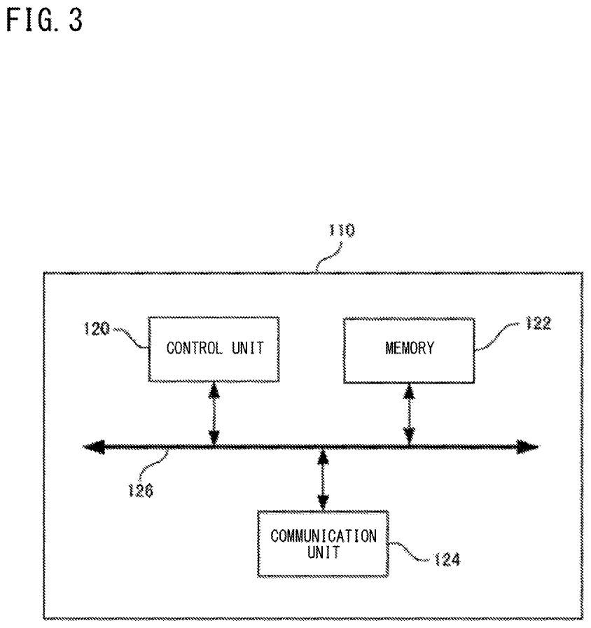

With reference to FIG. 3, the server 110 includes: a control unit 120 that controls components thereof; a memory 122 that stores data therein; a communication unit 124 that performs communication; and a bus 126 through which data is exchanged between the components. The control unit 120 includes a CPU (Central Processing Unit), and controls the components to implement functions described later. The memory 122 includes a rewritable nonvolatile semiconductor memory and a large-capacity storage device such as a hard disk drive (hereinafter referred to as “HDD”). The communication unit 124 receives, via the base station 106, sensor information uploaded from the infrastructure sensor 102 installed on a road, sensor information uploaded from the on-vehicle devices 140 and 154 of the vehicles 112 and 114, and traffic information uploaded from the traffic signal unit 104. The data received by the communication unit 124 are transferred to the memory 122 to be stored therein. Thus, the server 110 functions as an information providing device as described later.

### [Hardware Configuration and Function of On-Vehicle Device]

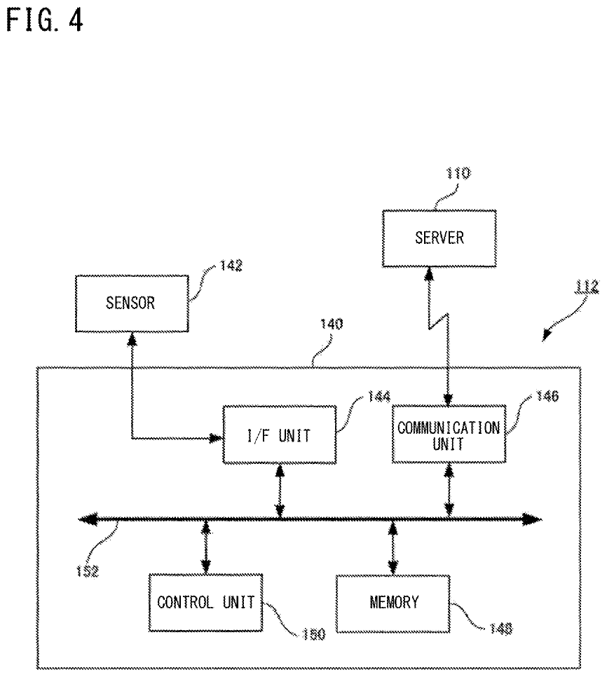

FIG. 4 shows an example of the hardware configuration of the on-vehicle device 140 mounted on the vehicle 112. The on-vehicle device 154 of the vehicle 114 has the same configuration as the on-vehicle device 140. The on-vehicle device 140 includes: an interface unit (hereinafter referred to as “I/F unit”) 144 connected to one or a plurality of sensors 142 mounted on the vehicle 112; a communication unit 146 that performs wireless communication; a memory 148 that stores data therein; a control unit 150 that controls these components; and a bus 152 through which data is exchanged between the components.

The sensor 142 is a known video image capturing device (e.g., digital camera (CCD camera, CMOS camera)), a laser sensor (LiDAR), or the like mounted on the vehicle 112. When the sensor 142 is a digital camera, the sensor 142 outputs a predetermined video signal (analog signal or digital data). The signal outputted from the sensor 142 is inputted to the I/F unit 144. The I/F unit 144 includes an A/D converter, and when an analog signal is inputted, samples the analog signal at a predetermined frequency, and generates and outputs digital data (sensor information). The generated digital data is transmitted to the memory 148 to be stored therein. If the output signal from the sensor 142 is digital data, the I/F unit 144 stores the inputted digital data in the memory 148. The memory 148 is, for example, a rewritable nonvolatile semiconductor memory or an HDD.

The communication unit 146 has a mobile communication function using a 5G line or the like, and communicates with the server 110. Communication between the on-vehicle device 140 and the server 110 is performed via the base station 106. The communication unit 146 is composed of an IC for performing modulation and multiplexing adopted for the 5G line or the like, an antenna for radiating and receiving radio waves having a predetermined frequency, an RF circuit, and the like.

The control unit 150 includes a CPU, and controls the respective components to implement the functions of the on-vehicle device 140. For example, the control unit 150 transmits, to the server 110, sensor information acquired from the sensor 142. At this time, the control unit 150 adds, to the sensor information, information specifying the on-vehicle device 140, information of the current position and heading of the vehicle 112, and information regarding the sensor 142, and transmits the sensor information. The information specifying the on-vehicle device 140 is, for example, an ID that has been uniquely assigned to each on-vehicle device in advance. The control unit 150 acquires the current position of the vehicle 112 by using a GPS. The transmitted sensor information is used by the server 110 to generate driving support information. The information of the current position and heading of the vehicle 112 and the information regarding the sensor 142 are used for specifying correspondence between the sensor information (e.g., an image obtained by the sensor) and a position on a map. Upon receiving the driving support information from the server 110, the control unit 150 performs a process of controlling traveling of the vehicle 112, a process of providing information that supports a driver, etc. In addition, the control unit 150 analyzes the data acquired from the sensor 142 to detect an object around the vehicle 112, and uses the analysis result for driving support. In addition, apart from transmission of the sensor information, the control unit 150 transmits, to the server 110, the current position of the vehicle 112 as information regarding the vehicle 112 (hereinafter also referred to as “vehicle information”) as appropriate or upon receiving a request from the server 110. The server 110 broadcasts a transmission request for position information, for example.

### [Hardware Configuration and Function of Infrastructure Sensor]

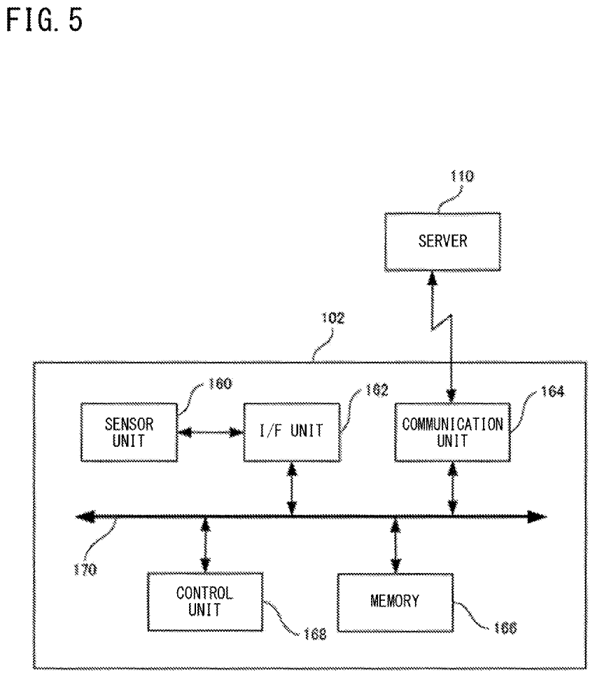

The infrastructure sensor 102 has basically the same configuration as the on-vehicle device 140. FIG. 5 shows an example of the hardware configuration of the infrastructure sensor 102. The infrastructure sensor 102 includes: an I/F unit 162 connected to a sensor unit 160; a communication unit 164 that performs wireless communication; a memory 166 that stores data therein; a control unit 168 that controls these components; and a bus 170 through which data is exchanged between the components.

The sensor unit 160 is, for example, a known video image capturing device (e.g., digital camera). The sensor unit 160 acquires information around the infrastructure sensor 102, and outputs the information as sensor information. When the sensor unit 160 is a digital camera, the sensor unit 160 outputs digital image data. A signal (analog or digital) from the sensor unit 160 is inputted to an I/F unit 162. The I/F unit 162 includes an A/D converter, and when an analog signal is inputted, generates and outputs digital data (sensor information). The generated digital data is transferred to the memory 166 to be stored therein. If the output signal from the sensor unit 160 is digital data, the I/F unit 162 stores the inputted digital data in the memory 166. The memory 166 is, for example, a rewritable nonvolatile semiconductor memory or an HDD.

The communication unit 164 has a mobile communication function, and communicates with the server 110 via the base station 106. Since the infrastructure sensor 102 is fixedly installed, the infrastructure sensor 102 need not conform to a plurality of mobile communication systems, and only needs to conform to the mobile communication system (e.g., 5G line) provided by a nearby base station 106. The communication unit 164 is composed of an IC for performing adopted modulation and multiplexing, an antenna for radiating and receiving radio waves having a predetermined frequency, an RF circuit, and the like. The communication function of the fixedly installed infrastructure sensor 102 is not limited to one via the base station 106, and any communication function may be adopted. A communication function using a wired LAN or a wireless LAN such as WiFi may be adopted. In the case of WiFi communication, a device (wireless router, etc.) for providing a WiFi service is provided separately from the base station 106 for mobile communication, and the infrastructure sensor 102 communicates with the server 110 via the network 108.

The control unit 168 includes a CPU, and controls the respective components to implement the functions of the infrastructure sensor 102. That is, the control unit 168 reads out, at predetermined time intervals, the sensor information (e.g., moving image data) acquired by the sensor unit 160 and stored in the memory 166, generates packet data, and transmits the packet data from the communication unit 164 to the server 110 via the base station 106. At this time, the control unit 168 adds, to the sensor information, information for specifying an area (e.g., an imaging area by a camera) where the sensor information is acquired by the sensor unit 160, and transmits the sensor information. For example, if the server 110 stores therein information of an area where the infrastructure sensor 102 acquires the sensor information from the sensor unit 160 (e.g., information indicating correspondence between an image captured by a camera and map information) in association with information specifying the infrastructure sensor 102 (e.g., an ID uniquely assigned to each infrastructure sensor in advance), the infrastructure sensor 102 may add its own ID to the sensor information to be transmitted.

### [Hardware Configuration and Function of Traffic Signal Unit]

The traffic signal unit 104 is a known traffic signal unit for road traffic. A traffic signal unit for vehicles includes: signal lights of three colors (green, yellow, and red); a control unit for controlling lighting and blinking of the signal lights; and a communication unit for transmitting traffic information that indicates the states of the signal lights to the server 110. A traffic signal unit for pedestrians has the same configuration as the traffic signal unit for vehicles except that it includes signal lights of two colors (green and red). The communication unit of the traffic signal unit 104 has a mobile communication function and communicates with the server 110 via the base station 106, similarly to the communication unit 164 of the infrastructure sensor 102. The fixedly installed traffic signal unit 104 may have any communication function. A communication function using a wired LAN or a wireless LAN such as WiFi may be adopted. The control unit of the traffic signal unit 104 includes a CPU. The control unit controls lighting and blinking of each signal light, and transmits traffic information indicating the current state of the traffic signal unit to the server 110 via the base station 106 each time the state of the signal light is changed. At this time, the traffic signal unit 104 adds, to the traffic information, information specifying itself (e.g., position coordinates, an ID uniquely assigned to each traffic signal unit in advance, etc.), and transmits the traffic information.

### [Functional Configuration of Server]

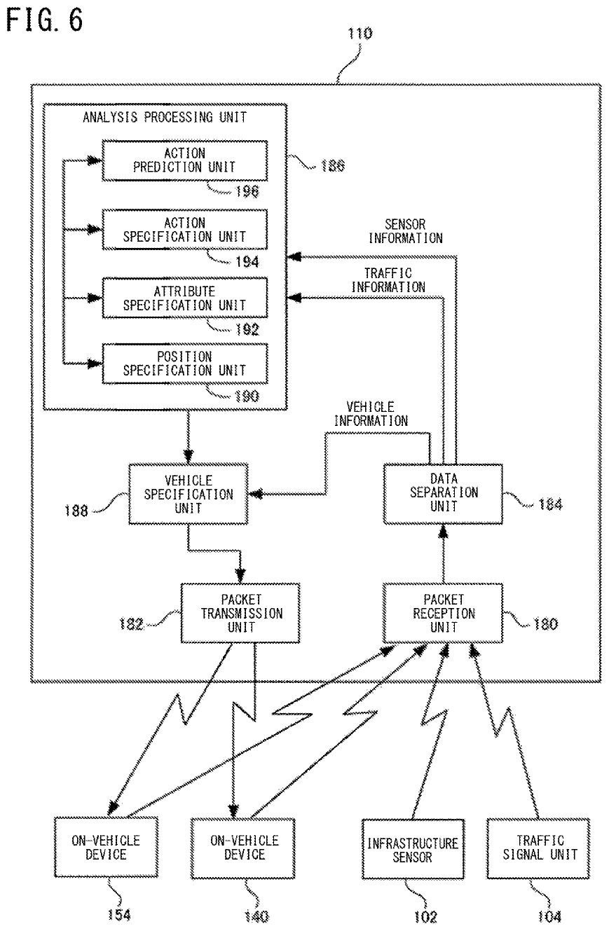

The function of the server 110 will be described with reference to FIG. 6. The server 110 includes: a packet reception unit 180 that receives packet data; a packet transmission unit 182 that transmits packet data; a data separation unit 184 that outputs received data to a destination according to the type of the received data; an analysis processing unit 186 that executes a predetermined analysis process by using inputted data; and a vehicle specification unit 188 that specifies a vehicle. The functions of the packet reception unit 180, the packet transmission unit 182, the data separation unit 184, the analysis processing unit 186, and the vehicle specification unit 188 are implemented by the control unit 120 shown in FIG. 3 using the memory 122 and the communication unit 124. The functions of the data separation unit 184, the analysis processing unit 186, and the vehicle specification unit 188 may be implemented by dedicated hardware (circuit board, ASIC, etc.).

The packet reception unit 180 receives packet data from the infrastructure sensor 102, the traffic signal unit 104, the on-vehicle device 140, and the on-vehicle device 154, and outputs the received data to the data separation unit 184.

If the received data is data from the infrastructure sensor 102, the data separation unit 184 inputs the data to the analysis processing unit 186. If the received data is data (traffic information) from the traffic signal unit 104, the data separation unit 184 inputs the data to the analysis processing unit 186. When the received data is data from the on-vehicle device 140 or the on-vehicle device 154, the data separation unit 184 inputs the data to the analysis processing unit 186 if the data is sensor information, and to the vehicle specification unit 188 if the data is vehicle information.

The analysis processing unit 186 executes an analysis process by using the inputted data to detect a pedestrian and a vehicle, and calculates attribute information and the like regarding them. The “pedestrian” means a person who is moving at any speed (including “0”), and includes not only a walking person but also a stopped person and a running person. Although one pedestrian 200 is shown in FIG. 1, if a plurality of persons are included in uploaded moving image data, each person is detected.

The analysis processing unit 186 is composed of a position specification unit 190, an attribute specification unit 192, an action specification unit 194, and an action prediction unit 196. To the position specification unit 190, data (sensor information) received from sensors such as a LiDAR and a millimeter-wave radar (hereinafter collectively referred to as “radar sensor”) are inputted. Then, the position specification unit 190 detects a pedestrian and a vehicle, and specifies “position information” for each of the detected objects. As described above, regardless of the sensor information having been transmitted from either an infrastructure sensor or an on-vehicle device, since information for specifying an area where the sensor information has been acquired is assigned to the sensor information, the position specification unit 190 can specify the position and size of each detected object with reference to map information. Here, the position information is, for example, a two-dimensional position (latitude and longitude), an altitude (height from a reference level), a moving speed, a moving direction, rough classification (pedestrian or vehicle), etc.

When pieces of sensor information from a plurality of radar sensors are analyzed, if the radar sensors include sensor information in the same area, the radar sensors are likely to detect the same object. In this case, the same object is specified, and pieces of position information specified from the sensor information of the radar sensors are preferably integrated.

To the attribute specification unit 192, data (sensor information) received from an image sensor (camera, etc.) and position information specified by the position specification unit 190 are inputted. Then, the attribute specification unit 192 detects a pedestrian and a vehicle, and specifies an “attribute” regarding each of the detected objects. The sensor information from the image sensor may not necessarily be moving image data, and only needs to be at least one image (static image). Here, the “attribute” is, for example, detailed classification. If the detected object is a person, the attribute of the person includes his/her type (e.g., child, adult, elderly), his/her state (e.g., viewing a smart phone, a tablet, a book, or the like while walking (hereinafter also referred to as “using a smart phone while walking”), or the like), details of his/her moving direction (e.g., face orientation, body orientation, etc.), and the like. If the detected object is a vehicle, the attribute (detailed classification) of the vehicle includes the vehicle type (e.g., general vehicle, large vehicle, emergency vehicle, etc.), the traveling state (e.g., stop, normal traveling, winding driving, etc.), and the like. Even with one static image, it is possible to determine whether the vehicle is travelling normally or windingly from the positional relationship between the vehicle and a white line on the road.

Since the position information specified by the position specification unit 190 is inputted to the attribute specification unit 192, it is determined whether or not the object detected by the attribute specification unit 192 is the same as the object detected by the position specification unit 190, so that the position information and the attribute can be associated with the same detected object. When pieces of sensor information from a plurality of image sensors are analyzed, if the image sensors include sensor information in the same area, the image sensors are likely to detect the same object. In this case, the same object is specified, and attributes specified from the sensor information of the image sensors are preferably integrated.

To the action specification unit 194, data (sensor information) received from the radar sensor and the image sensor, data (traffic information) received from the traffic signal unit, and information (position information and attribute) specified by the position specification unit 190 and the attribute specification unit 192 are inputted. Then, the action specification unit 194 specifies an “action pattern” of each of the detected objects. The action specification unit 194 uses map information according to need. The map information may be stored in the memory 122 in advance. For example, if the detected object is a pedestrian, the action pattern of the pedestrian includes normal walking, a dangerous action (e.g., jaywalking), or the like. If the detected object is a vehicle, the action pattern of the vehicle includes normal traveling, dangerous traveling (e.g., speeding, drunk driving), or the like. The action specification unit 194 determines the action pattern by using a plurality of position information, attributes, and traffic information at different times. The action specification unit 194 can determine the action pattern from, for example, a temporal change in the two-dimensional position, moving speed, moving direction, and lighting state of the traffic signal unit.

To the action prediction unit 196, data (sensor information) received from the radar sensor and the image sensor, data (traffic information) received from the traffic signal unit, and information (position information, attribute, and action pattern) specified by the position specification unit 190, the attribute specification unit 192, and the action specification unit 194 are inputted. Then, the action prediction unit 196 specifies “action prediction” of the detected object in near future. The action prediction unit 196 uses the map information according to need. The action prediction includes, for example, position information, an attribute, and an action pattern of the detected object at a time after N seconds (N>0), for example. The action prediction unit 196 determines action prediction by using a plurality of position information, attributes, action patterns, and traffic information at different times. The action prediction unit 196 can predict the two-dimensional position, moving speed, moving direction, and action pattern of the detected object at the time after N seconds, from, for example, a temporal change in the two-dimensional position, moving speed, moving direction, action pattern, and lighting state of the traffic signal unit.

As described above, the analysis processing unit 186 executes a plurality of types of analysis processes in such a manner that the result of one analysis process is used in the subsequent analysis processes, and finally generates an analysis result that is hierarchized in the order of the analysis processes. That is, the analysis result obtained by the analysis processing unit 186 includes hierarchical layers corresponding to “position information”, “attribute”, “action pattern”, and “action prediction”. The analysis processing unit 186 inputs the information regarding each detected object (position information, attribute, action pattern, and action prediction) specified as described above, to the vehicle specification unit 188 so as to transmit the information as driving support information to the on-vehicle devices.

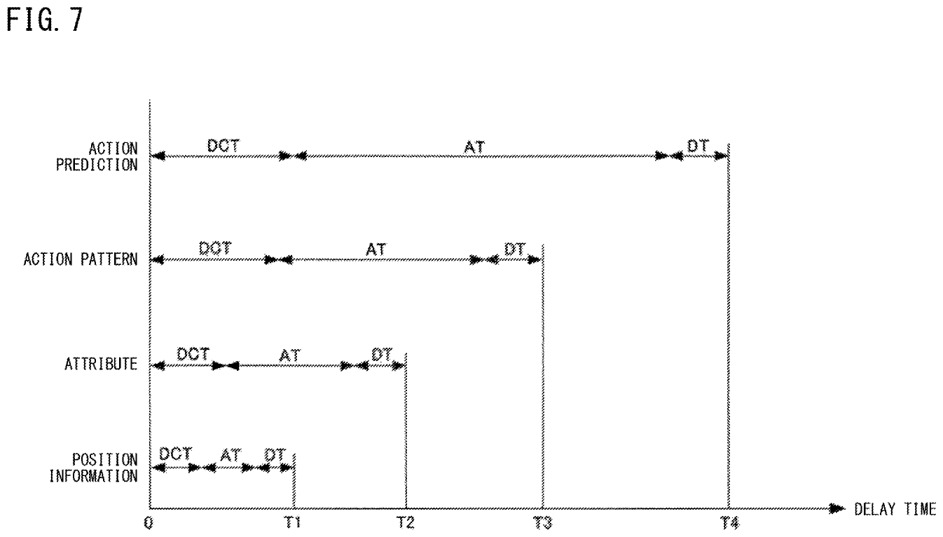

Although the driving support information includes the aforementioned position information, attribute, action pattern, and action prediction, since their delay times are different from each other, it is preferable to determine information to be transmitted and a vehicle (on-vehicle device) to which the information should be transmitted, while taking into consideration the delay times. A system latency (hereinafter also referred to simply as “latency”) SL increases in the order of position information, attribute, action pattern, and action prediction. Here, the latency SL is the sum of: a data collection time DCT from when sensor information is collected by a sensor to when the sensor information is received by the server 110 via the communication line; an analysis time AT during which the aforementioned analysis process is executed by the server 110; and a distribution time DT from when the analysis result is transmitted as driving support information to the server 110 to when the driving support information is received by an on-vehicle device (SL=DCT+AT+DT). FIG. 7 schematically shows delay times T1 to T4 of position information, attribute, action pattern, and action prediction, and DCT, AT, and DT constituting each delay time.

The position information is specified by use of the data (sensor information) received from the radar sensor, and the data amount of the sensor information is smaller than the data amount of the sensor information from the image sensor. Therefore, the delay time T1 shown in FIG. 7 is relatively small. For example, the delay time T1 of a LiDAR ranges from several tens of milliseconds to several hundreds of milliseconds.

The attribute is specified by use of the data (sensor information) received from the image sensor, and the data amount of the sensor information from the image sensor is greater than the data amount of the sensor information from the radar sensor. Therefore, the delay time T2 shown in FIG. 7 is relatively long. For example, the delay time T2 of a digital camera ranges from several hundreds of milliseconds to about 1 second, although it depends on compression/non-compression of data.

The action pattern is specified by use of the data (sensor information) received from the radar sensor and the image sensor, the position information, and the attribute. As described above, since the data amount of the sensor information from the image sensor is relatively large and the time (analysis time AT) required for specifying the action pattern is relatively long, the delay time T3 of the action pattern shown in FIG. 7 is longer than the delay time T2 of the attribute and is shorter than the delay time T4 of the action prediction described below.

The action prediction is specified by use of the data (sensor information) received from the radar sensor and the image sensor, the position information, the attribute, and the action pattern. As described above, the data amount of the sensor information from the image sensor is relatively great and the time (analysis time AT) required for specifying the action prediction is relatively long. Therefore, the delay time T4 of the action prediction shown in FIG. 7 is longer than the delay time T3 of the action pattern. For example, the delay time T4 of the action prediction is several seconds.

Using the driving support information received from the analysis processing unit 186 and the vehicle information received from the data separation unit 184, the vehicle specification unit 188 specifies a vehicle to which the driving support information should be transmitted, and transmits the driving support information to the specified vehicle (on-vehicle device). The vehicle specification unit 188 is an example of a selection unit. That is, the vehicle specification unit 188 selects a hierarchical layer to be included in the driving support information from the analysis result, based on the positional relationship between the detected object (first dynamic object) and the vehicle (second dynamic object) to which the driving support information should be transmitted. Transmission of the driving support information is performed by the packet transmission unit 182, and packet data including the driving support information is transmitted. The packet transmission unit 182 is an example of an output unit.

The vehicle specification unit 188 stores, in the memory 122, the inputted vehicle information (ID, position coordinates, etc.) together with time information. At this time, with reference to the ID of the vehicle, if there is information of the same ID stored in the memory 122 in the past, the vehicle information is stored in the memory 122 in association with this information. Using the position coordinates of the detected object included in the driving support information and the position coordinates of each vehicle, the vehicle specification unit 188 calculates the distance between the detected object and the vehicle, selects the type (i.e., hierarchical layer) of the driving support information to be transmitted, according to the calculated distance and the traveling direction, and specifies a vehicle to which the driving support information should be transmitted.

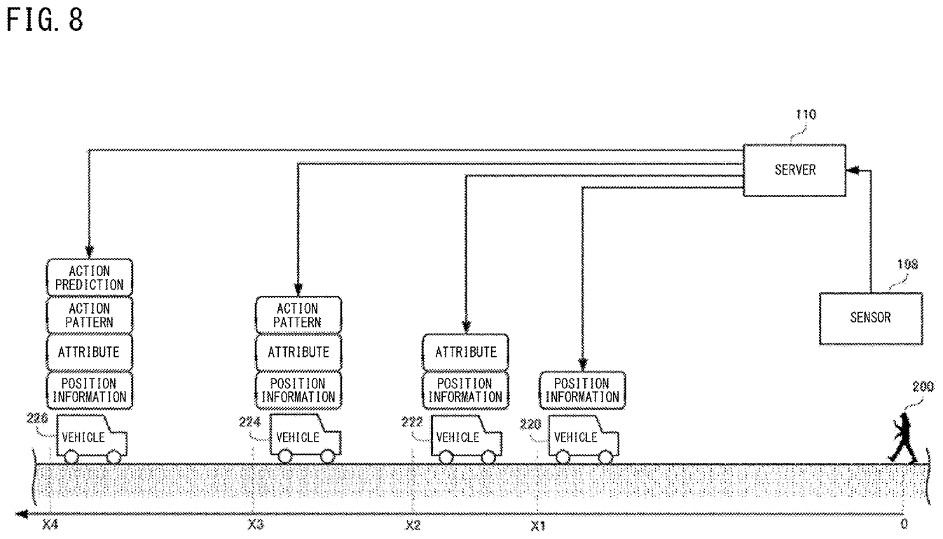

A specific description will be given with reference to FIG. 8. FIG. 8 shows four vehicles at a certain time, and a pedestrian 200 (detected object) detected by a sensor 198 (including an infrastructure sensor and an on-vehicle sensor). The vehicle specification unit 188 specifies an on-vehicle device of a vehicle (e.g., vehicle 220) having a distance X, from the detected object, equal to or less than X1 (0≤X≤X1) and traveling toward the detected object, and then specifies position information as driving support information to be transmitted to the specified on-vehicle device. The vehicle specification unit 188 specifies an on-vehicle device of a vehicle (e.g., vehicle 222) having a distance X, from the detected object, that satisfies X1<X≤X2 and traveling toward the detected object, and then specifies position information and attribute as driving support information to be transmitted to the specified on-vehicle device. The vehicle specification unit 188 specifies an on-vehicle device of a vehicle (e.g., vehicle 224) having a distance X, from the detected object, that satisfies X2<X≤X3 and traveling toward the detected object, and then specifies position information, attribute, and action pattern as driving support information to be transmitted to the specified on-vehicle device. The vehicle specification unit 188 specifies an on-vehicle device of a vehicle (e.g., vehicle 226) having a distance X, from the detected object, that satisfies X3<X≤X4 and traveling toward the detected object, and then specifies position information, an attribute, an action pattern, and an action prediction as driving support information to be transmitted to the specified on-vehicle device. Whether or not a vehicle is traveling toward the detected object may be determined based on whether or not the detected object is included in an area, on a map, that is ahead of the vehicle and is within a predetermined central angle (e.g., 180 degrees) with the traveling direction of the vehicle as a central axis, for example. As described above, the relationship (rule) between the hierarchical layer to be selected and the positional relationship (distance and direction) between the detected object and the vehicle, may be determined in advance. According to the rule, the vehicle specification unit 188 selects a hierarchical layer corresponding to the positional relationship between the detected object and the vehicle.

As described above, the delay time of the driving support information increases in the order of position information, attribute, action pattern, and action prediction. For the on-vehicle device of a vehicle close to the detected object, information having a long delay time cannot be used for driving support and therefore is not necessary. For the on-vehicle device of a vehicle far from the detected object, even information having a long delay time can be used for driving support. Therefore, by changing the type of driving support information according to the distance from the detected object as described above with reference to FIG. 8, transmission of unnecessary data can be inhibited, and effective driving support information for each vehicle can be transmitted. That is, the vehicle specification unit 188 (selection unit) of the server 110 selects a predetermined hierarchical layer (type of drive information) according to the positional relationship between a vehicle and a detected object, and the packet transmission unit 182 (output unit) of the server 110 outputs information of the selected hierarchical layer.

### [Operation of Server]

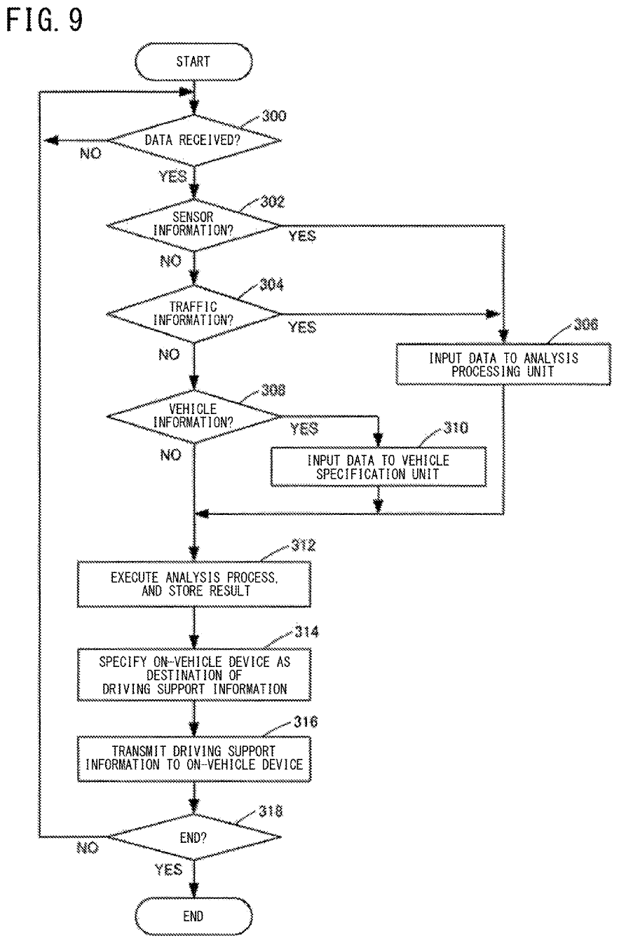

With reference to FIG. 9, the process performed by the server 110 will be described in more detail. The process shown in FIG. 9 is realized by the control unit 120 reading out a predetermined program from the memory 122 and executing the program. The memory 122 of the server 110 has, stored therein, map information of an information providing area of the server 110, including a range in which sensor information from each infrastructure sensor is collected. The memory 122 also has, stored therein, information (e.g., ID) specifying each infrastructure sensor and each traffic signal unit, and position coordinates thereof. The infrastructure sensor and the traffic signal unit each add its own ID to packet data to be transmitted to the server 110, and transmits the packet data. The memory 122 also has, stored therein, information of an area where sensor information is acquired from each infrastructure sensor.

In step 300, the control unit 120 determines whether or not data has been received. Upon determining that data has been received, the control unit 120 stores the received data in the memory 122, and the control proceeds to step 302. Otherwise, step 300 is repeated.

In step 302, the control unit 120 determines whether or not the data received in step 300 includes sensor information. Sensor information is transmitted from the infrastructure sensor 102, the on-vehicle device 140, and the on-vehicle device 154. When it has been determined that sensor information is included, the control proceeds to step 306. Otherwise, the control proceeds to step 304.

In step 304, the control unit 120 determines whether or not the data received in step 300 includes traffic information (information of a traffic signal unit) transmitted from the traffic signal unit 104. When it has been determined that traffic information is included, the control proceeds to step 306. Otherwise, the control proceeds to step 308. Traffic information includes, for example, data indicating a lighting color (green, yellow, or red) and its state (steadily lighting or blinking).

In step 306, the control unit 120 inputs the data received in step 300 to the analysis processing unit 186. Thereafter, the control proceeds to step 312. Specifically, when the data received in step 300 includes sensor information acquired by the radar sensor, the control unit 120 inputs the sensor information to the position specification unit 190, the action specification unit 194, and the action prediction unit 196 as described above. When the data received in step 300 includes sensor information acquired by the image sensor, the control unit 120 inputs the sensor information to the attribute specification unit 192, the action specification unit 194, and the action prediction unit 196 as described above. When the data received in step 300 includes traffic information, the control unit 120 inputs the traffic information to the action specification unit 194 and the action prediction unit 196 as described above.

In step 308, the control unit 120 determines whether or not the data received in step 300 includes vehicle information (position information, etc.) transmitted from a vehicle and regarding the vehicle. When it has been determined that vehicle information is included, the control proceeds to step 310. Otherwise, the control proceeds to step 312.

In step 310, the control unit 120 inputs the data (vehicle information) received in step 300 to the vehicle specification unit 188 in association with time information (e.g., data reception time).

In step 312, the control unit 120 executes an analysis process, and stores an analysis result in the memory 122. Specifically, as described above for the position specification unit 190, the attribute specification unit 192, the action specification unit 194, and the action prediction unit 196, the control unit 120 detects a person or a vehicle, specifies position information, an attribute, an action pattern, and an action prediction of the detected object, and stores them in the memory 122.

In step 314, the control unit 120 specifies an on-vehicle device to which driving support information should be transmitted, and the type of driving support information to be transmitted to the on-vehicle device. Specifically, as described above for the vehicle specification unit 188 with reference to FIG. 8, the control unit 120 calculates the distance between the detected object and each vehicle included in the driving support information, and specifies, according to the calculated distance, an on-vehicle device of a vehicle to which the driving support information should be transmitted, and the type of driving support information to be transmitted.

In step 316, the control unit 120 reads out the specified type of driving support information from the memory 122, and transmits the driving support information to the on-vehicle device specified in step 314. As described above, the delay time increases in the order of position information, attribute, action pattern, and action prediction. One of the causes of this is as follows. That is, the frequency of receiving sensor information by the server 110 depends on the type of sensor (radar sensor or image sensor), and the analysis processing time depends on the type of analysis (position information, attribute, action pattern, or action prediction). That is, the update frequency of the analysis result obtained by the analysis processing unit 186 decreases in the order of the position specification unit 190, the attribute specification unit 192, the action specification unit 194, and the action prediction unit 196. Therefore, each time the analysis result is updated, the control unit 120 can transmit only the updated information (any of position information, attribute, action pattern, and action prediction). That is, since the driving support information is hierarchized, data of the respective hierarchical layers are transmitted at different timings, in ascending order of the delay times. Usually, data of each hierarchical layer are transmitted as a plurality of packet data, and the respective packet data are transmitted at different times. However, in this embodiment, it is assumed that a plurality of packet data for transmitting data of one hierarchical layer are transmitted at the same timing. That is, “timing” does not correspond to the transmission time of each packet data, but indicates a time (representative time) representing a transmission time of each packet data when data of each hierarchical layer is transmitted, or the relationship of times before and after the representative time.

In step 318, the control unit 120 determines whether or not an instruction of end has been received. When it has been determined that an instruction of end has been received, this program is ended. Otherwise, the control returns to step 300. The instruction of end is made by the server 110 being operated by an administrator or the like, for example.

As described above, the server 110 specifies (selects), out of the hierarchized driving support information, a hierarchical layer (type) to be transmitted, according to the distance between a detected object and a vehicle, whereby the server 110 can transmit, to each vehicle, driving support information useful for the vehicle. Therefore, transmission of unnecessary data is inhibited, and increase in communication traffic can be inhibited.

### [Use of Driving Support Information by Vehicle]

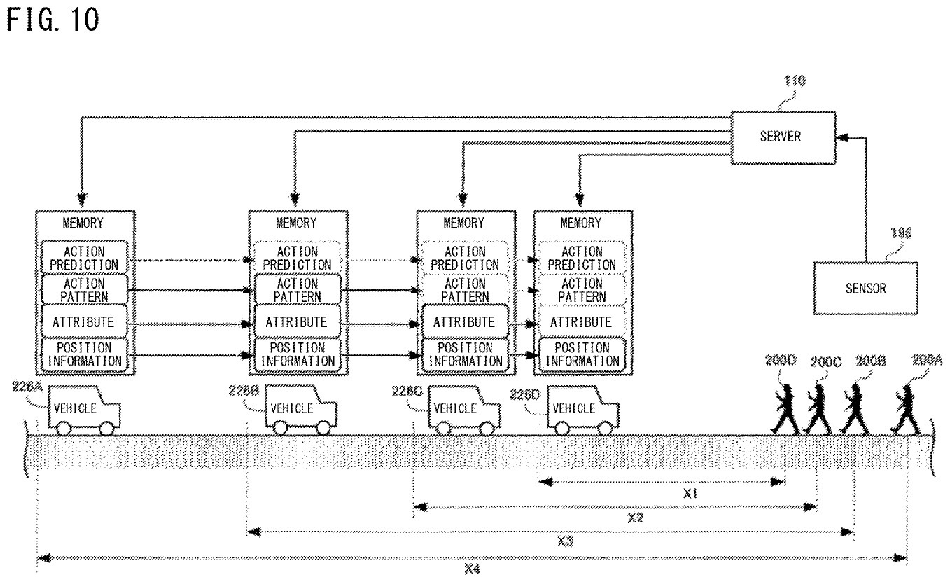

With reference to FIG. 10, how driving support information, which has been transmitted from the server 110 and received by an on-vehicle device of a vehicle, changes as the vehicle approaches a detection object, will be described. In FIG. 10, vehicles 226A to 226D indicate the vehicle 226 at different time points after the elapse of certain amounts of time from the time in FIG. 8. Likewise, pedestrians 200A to 200D indicate the pedestrian 200 at different time points after the elapse of certain amounts of time from the time in FIG. 8. The pedestrians 200A to 200D indicate that the pedestrian 200 is using a smart phone while walking. A vehicle and a pedestrian that are given the same alphabet are at the same time point.

The on-vehicle device of the vehicle 226A traveling at a position where the vehicle-pedestrian distance X is X4≥X>X3, receives position information, an attribute, an action pattern, and an action prediction as driving support information from the server 110, and stores them in the memory.

The on-vehicle device of the vehicle 226B traveling at a position where the vehicle-pedestrian distance X is X3≥X>X2, receives position information, an attribute, and an action pattern as driving support information from the server 110, and stores them in the memory. The vehicle 226B does not receive an action prediction, but retains the action prediction received in the past and stored in the memory (e.g., the action prediction received last time). In FIG. 10, a solid rightward arrow means that, during the period thereof, the corresponding information is transmitted from the server 110 and updated, and a broken rightward arrow means that, during the period thereof, the corresponding information is not transmitted from the server 110 and is not updated. Information enclosed by a broken line is information that was stored in the past and is not updated.

The on-vehicle device of the vehicle 226C traveling at a position where the vehicle-pedestrian distance X is X2≥X>X1, receives position information and an attribute as driving support information from the server 110, and stores them in the memory. The vehicle 226C does not receive an action pattern and an action prediction, but stores the action pattern and the action prediction received in the past.

The on-vehicle device of the vehicle 226D traveling at a position where the vehicle-pedestrian distance X is X1≥X>0, receives position information as driving support information from the server 110 and stores the information in the memory. The vehicle 226D does not receive an attribute, an action pattern, and an action prediction, but stores the attribute, the action pattern, and the action prediction received in the past.

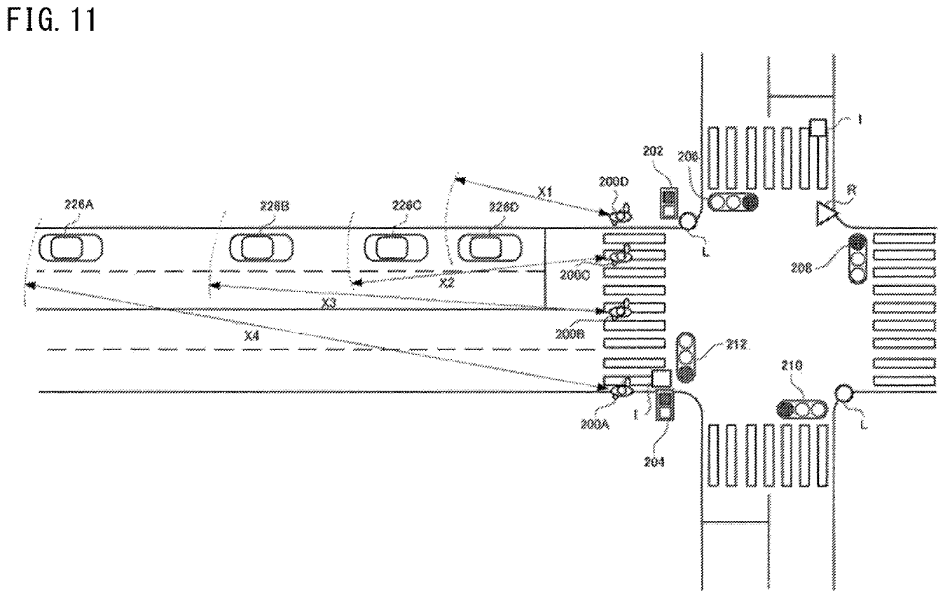

When driving support information received by one vehicle has been changed as described above, information to be provided by the on-vehicle device of the vehicle will be changed. This will be described with reference to FIGS. 11 to 13. FIG. 11 two-dimensionally shows the vehicles 226A to 226D and the pedestrians 200A to 200D shown in FIG. 10. At an intersection shown in FIG. 11, a plurality of traffic signal units and an infrastructure sensor are installed as shown in FIG. 2. FIG. 11 shows a state where the traffic signal unit 202 for pedestrians is red, and the traffic signal unit 208 for vehicles is green, as in FIG. 2. In FIG. 11, four broken lines are arcs having radii X4 to X1 and centering around the pedestrians 200A to 200D, respectively. When the traffic signal unit 202 for pedestrians is red, the pedestrian 200 (pedestrians 200A to 200D) crosses a crosswalk while using a smart phone and ignoring the red light.

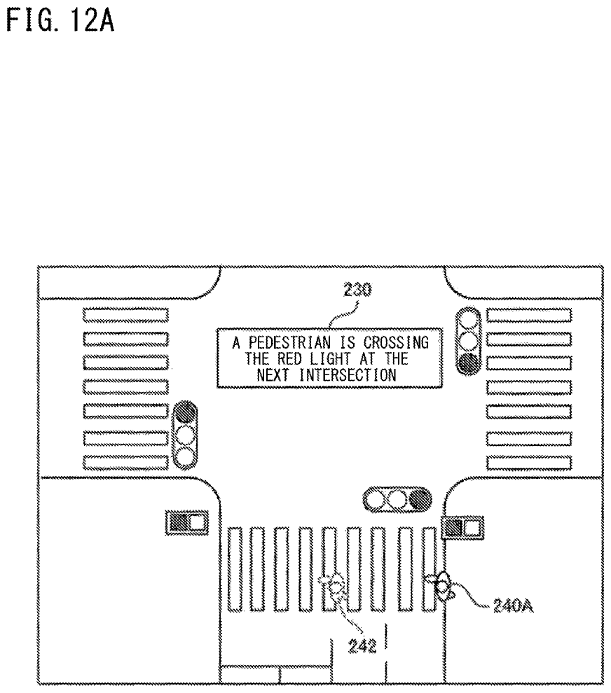

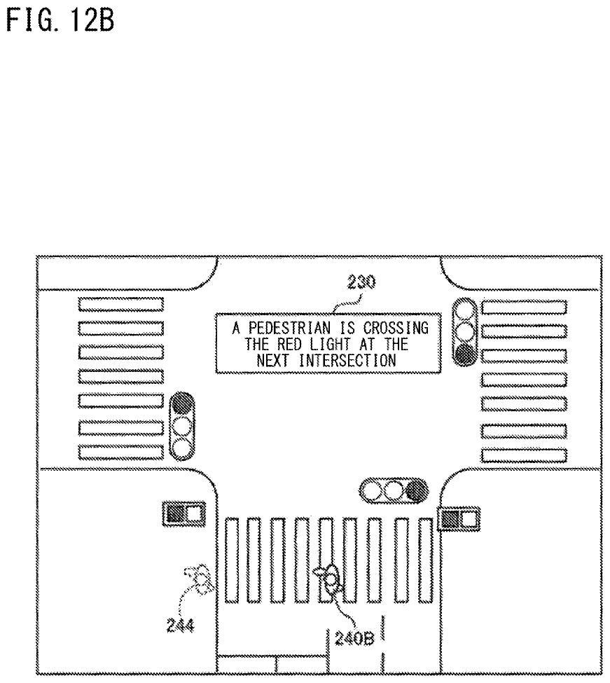

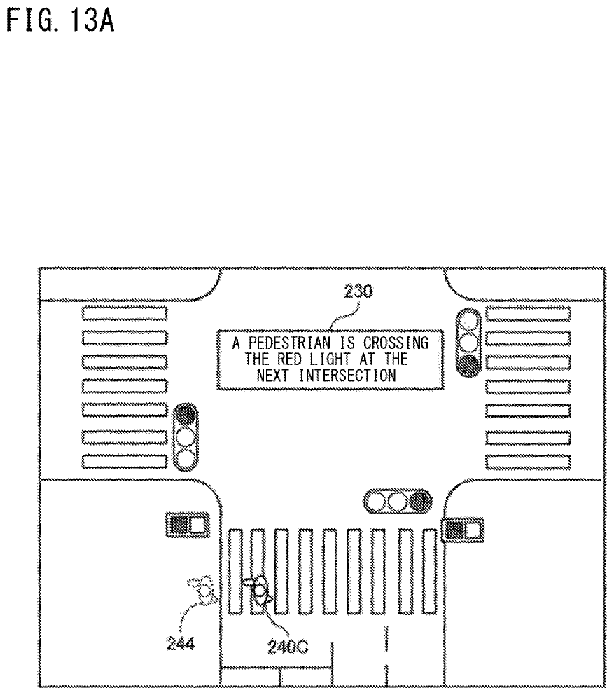

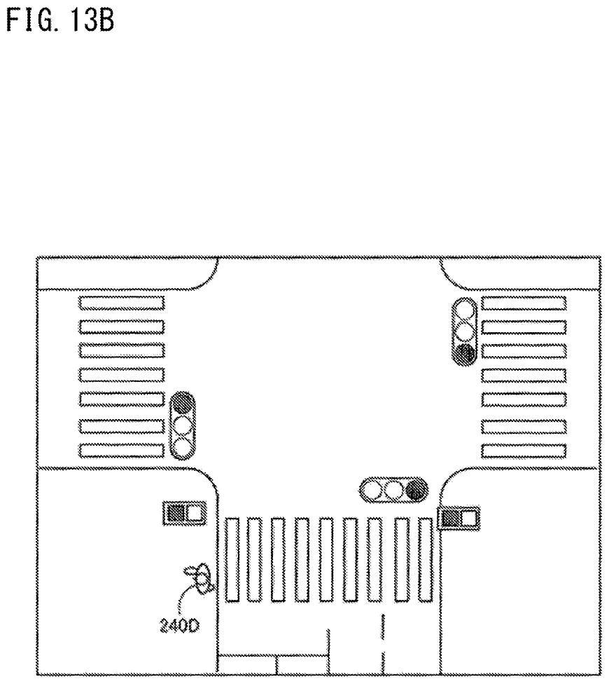

In FIG. 11, it is assumed that the pedestrian 200B indicates a pedestrian that is N seconds after the pedestrian 200A, and the pedestrian 200D indicates a pedestrian that is N seconds after the pedestrian 200B. Under such circumstances, the on-vehicle device of the vehicles 226A to 226D provides the driver with information as shown in FIG. 12A, FIG. 12B, FIG. 13A, and FIG. 13B, respectively.

As described above with reference to FIG. 10, the on-vehicle device of the vehicle 226A traveling at the position where the distance X to the detected object (pedestrian 200A) is X4≥X>X3, receives, as driving support information, position information, an attribute, an action pattern, and an action prediction. Therefore, the on-vehicle device can specify, from the received driving support information, a dangerous state that may cause an accident (a pedestrian who has started jaywalking at the intersection located in the advancing direction of the vehicle). Accordingly, the on-vehicle device displays, for example, a map around the intersection and a warning message 230 on a part of a display screen of a car navigation system as shown in FIG. 12A, and displays a graphic symbol 240A indicating the current pedestrian (pedestrian 200A) at a position on the map corresponding to a two-dimensional position included in the received position information. Furthermore, the on-vehicle device displays a predicted graphic symbol 242 indicating the pedestrian in the future, at a position on the map corresponding to a two-dimensional position of the detected object after N seconds, included in the received action prediction. In FIG. 12A, a graphic symbol displayed at a position specified by the position information is indicated by a solid line while a graphic symbol displayed at a position specified by the action prediction is indicated by a broken line (the same applies to FIG. 12B, FIG. 13A, and FIG. 13B).

Thus, the driver of the vehicle knows that there is a pedestrian who has started to cross the crosswalk while ignoring the signal light, at the intersection ahead, and understands that careful driving is required.

Thereafter, the on-vehicle device of the vehicle 226B traveling at the position where the distance X to the detected object (pedestrian 200B) is X3≥X>X2, receives position information, an attribute, and an action pattern as driving support information. As described above, the on-vehicle device of the vehicle 226B retains the action prediction received in the past and stored in the memory (e.g., the action prediction received last time). Therefore, the on-vehicle device can determine, from the received driving support information, that the dangerous state still remains. Accordingly, the on-vehicle device maintains the warning message 230 displayed on the map, and displays a graphic symbol 240B indicating the current pedestrian (pedestrian 200B) at a position on the map corresponding to a two-dimensional position included in the received position information, as shown in FIG. 12B. Furthermore, the on-vehicle device displays a predicted graphic symbol 244 indicating the pedestrian in the future, at a position on the map corresponding to a two-dimensional position of the detected object included in the past action prediction stored in the memory.

Thereafter, the on-vehicle device of the vehicle 226C traveling at the position where the distance X to the detected object (pedestrian 200C) is X2≥X>X1, receives position information and an attribute as driving support information. As described above, the on-vehicle device of the vehicle 226C retains the action pattern and the action prediction received in the past and stored in the memory. Therefore, the on-vehicle device can determine, from the received driving support information, that the dangerous state still remains. Accordingly, the on-vehicle device maintains the warning message 230 displayed on the map, and displays a graphic symbol 240C indicating the current pedestrian (pedestrian 200C) at a position on the map corresponding to a two-dimensional position included in the received position information, as shown in FIG. 13A. The on-vehicle device maintains the predicted graphic symbol 244 displayed at the position on the map corresponding to the two-dimensional position of the detected object included in the past action prediction stored in the memory.

By the presentation as shown in FIG. 12B and FIG. 13A, the driver of the vehicle knows that there is a pedestrian crossing the crosswalk while ignoring the traffic signal, at the intersection ahead, and understands that careful driving is still required.

Thereafter, the on-vehicle device of the vehicle 226D traveling at the position where the distance X to the detected object (pedestrian 200D) is X1≥X>0, receives position information as driving support information. As described above, the on-vehicle device of the vehicle 226D retains the attribute, the action pattern, and the action prediction received in the past and stored in the memory. Therefore, the on-vehicle device can determine, from the received driving support information, that the pedestrian (detected object) who was jaywalking is on a sidewalk. Accordingly, as shown in FIG. 13B, the on-vehicle device deletes the warning message 230 from the displayed map, and displays, on the map, a graphic symbol 240D indicating the current pedestrian (pedestrian 200D) at a position corresponding to a two-dimensional position included in the received position information.

Thus, the driver of the vehicle knows that the pedestrian has finished crossing the crosswalk and is present on the sidewalk, at the intersection ahead, and understands that the danger has passed.

As described above, the on-vehicle device receives the hierarchized driving support information transmitted from the server 110 according to the distance from the detected object, whereby the on-vehicle device can present, to the driver of the vehicle, occurrence of a dangerous state, and make a warning. Since the type (hierarchical layer) of the received driving support information changes according to the distance from the detected object, the on-vehicle device can appropriately perform driving support without receiving unnecessary information for the vehicle.

Although the 5G line is used in the above description, any wireless communication such as WiFi may be adopted.

Although a pedestrian is an object to be detected in the above description, the object to be detected is not limited thereto. Any moving object that is likely to be bumped and damaged by a vehicle may be adopted as an object to be detected. For example, a person riding a bicycle, an animal, etc., may be adopted.

In the above description, an analysis result is transmitted as hierarchized driving support information to an on-vehicle device of a vehicle. However, the present disclosure is not limited thereto. The analysis result may be transmitted to a terminal device (smart phone, mobile phone, tablet, etc.) carried by a person. In this case, for example, the type of information (position information, attribute, action pattern, and action prediction) of a detected vehicle may be selected and transmitted, according to the positional relationship between the terminal device and the detected vehicle. Thus, it is possible to warn the person that a vehicle being driven dangerously is approaching, by means of speech, a warning sound, etc., for example.

In the above description, sensor information from an on-vehicle sensor is transmitted to the server 110, and the server 110 analyzes the sensor information together with information received from an infrastructure sensor. However, the present disclosure is not limited thereto. The server 110 may have, as a target of the analysis process, only the sensor information from the infrastructure sensor. The server 110 may not necessarily receive the sensor information from the on-vehicle sensor. Even if the server 110 has received the sensor information from the on-vehicle sensor, the server 110 need not analyze the same to be used for generation of hierarchized driving support information.

In the above description, the server 110 receives traffic information from the traffic signal unit 104. However, the present disclosure is not limited thereto. The server 110 may acquire traffic information from, for example, an apparatus (computer, etc.) installed in a traffic control center that manages and controls traffic signal units, via the network 108. In this case, the traffic signal unit 104 may transmit the current traffic information to the traffic control center via a dedicated line, for example.

In the above description, in an on-vehicle device having received hierarchized driving support information, a dangerous state is displayed on a screen of a car navigation system. However, the type of information to be presented to a driver as driving support information and the manner of presenting the information are discretionary. For example, information may be presented by means of sound.

In the above description, in step 316, the control unit 120 transmits only the updated information. However, the present disclosure is not limited thereto. Non-updated information may be transmitted together with the updated information at the same timing. For example, when only position information has been updated, at least one of the latest attribute, action pattern, and action prediction, which are not updated, may be transmitted together with the updated position information at the same timing. The on-vehicle device can receive hierarchized information at one time, and therefore, can generate driving support information to be presented to the driver by using appropriate information according to the positional relationship between the vehicle and the detected object, as described above, for example. Meanwhile, the on-vehicle device can also generate driving support information to be presented to the driver by using only the updated information without using the non-updated information. At this time, update information (e.g., 1-bit flag) specifying whether or not the corresponding information has been updated, may be added to the information to be transmitted. This update information allows the on-vehicle device to determine whether or not the received information has been updated, without the necessity of performing a process of obtaining a difference between the received information and the information previously received and stored. Regarding the non-updated information, the on-vehicle device can retain only the latest information and discard the other information. Also in this case, the update information allows the on-vehicle device to easily determine whether or not to discard the information.

In the above description, the attribute specification unit 192 uses the position information as the analysis result of the position specification unit 190, the action specification unit 194 uses the position information and the attribute as the analysis results of the position specification unit 190 and the attribute specification unit 192, and the action prediction unit 196 uses the position information, the attribute, and the action pattern as the analysis results of the position specification unit 190, the attribute specification unit 192, and the action specification unit 194. However, the present disclosure is not limited thereto. Some or all of the position specification unit 190, the attribute specification unit 192, the action specification unit 194, and the action prediction unit 196 may individually analyze inputted sensor information. In the case of the individual analysis, the process of integration with respect to the same detected object may be performed at the end, for example.

In the above description, as driving support information, information hierarchized into four hierarchical layers of position information, attribute, action, and action prediction has been described. However, the present disclosure is not limited thereto. Driving support information only needs to be hierarchized according to the delay time of sensor information received by the on-vehicle device. Driving support information may include at least one of position information, an attribute, an action, and an action prediction. Driving support information may include three or less hierarchical layers or five or more hierarchical layers.

In the above description, the latency SL includes the distribution time DT. However, the distribution time DT does not differ so much among the position information, the attribute, the action, and the action prediction. In addition, the distribution time DT tends to be smaller than the data collection time DCT and the analysis time AT. Therefore, the distribution time DT need not be included in the latency SL.

In the above description, a hierarchical layer to be transmitted, among hierarchical layers of driving support information, is determined according to the linear distance between a detected object and each vehicle. However, the present disclosure is not limited thereto. A hierarchical layer to be transmitted may be determined according to the positional relationship between the detected object and each vehicle. That is, the server 110 may include a determination unit that determines the positional relationship between the detected object and each vehicle, according to at least one of the heading, speed, acceleration, and destination of the vehicle, for example, and the server 110 may select a hierarchical layer to be transmitted, based on the determined positional relationship. A hierarchical layer to be transmitted may be determined not according to the linear distance but according to a distance along a road on which the vehicle travels. A hierarchical layer to be transmitted may be determined while considering the traveling speed of the vehicle in addition to the distance between the detected object and the vehicle. Even with the same distance from the detected object, if the traveling speed differs, the arrival time at the detected object differs. Therefore, it is preferable that the on-vehicle device of a vehicle having a higher traveling speed receives driving support information at a position farther from the detected object than the on-vehicle device of a vehicle having a lower traveling speed. For example, a hierarchical layer to be transmitted can be determined according to a value obtained by dividing the distance by the traveling speed (expected time to arrive at the detected object). The acceleration of each vehicle may also be considered. Since a vehicle usually travels at around the speed limit, the speed limit set on the road may be used instead of the traveling speed of each vehicle. For example, a hierarchical layer to be transmitted can be determined according to a value obtained by dividing the distance by the speed limit.

In the above description, for each of the on-vehicle devices of vehicles, driving support information of a hierarchical layer according to the distance between the vehicle and the detected object is transmitted. However, the present disclosure is not limited thereto. Driving support information of the same hierarchical layer may be transmitted to a plurality of vehicles grouped under a predetermined condition. For example, driving support information of the same hierarchical layer may be multi-casted to vehicles the current positions of which are in a predetermined area. For example, using a known beacon installed on a road included in the predetermined area, driving support information may be transmitted (broadcast) to on-vehicle devices of vehicles traveling in the area. At this time, as described above, the hierarchical layer of the driving support information to be transmitted from the beacon is changed according to the distance between the predetermined area and a detected object. Although broadcasting that need not specify vehicles is performed, this transmission is regarded as multicasting because vehicles capable of receiving a signal from the beacon are limited. Since a cover area of each base station for mobile communication is limited, a base station whose cover area is relatively narrow may be used instead of a beacon. That is, the hierarchical layer of driving support information to be transmitted (broadcast) from each base station is changed according to the distance between the base station and the detected object.

In the above description, current position information of a vehicle is transmitted as vehicle information from the corresponding on-vehicle device to the server 110. However, the present disclosure is not limited thereto. For example, when a traveling destination (e.g., destination or traveling route) is set on a car navigation system, information thereof may be transmitted as vehicle information to the server 110. In a process (the vehicle specification unit 188) of specifying a vehicle to which driving support information should be transmitted, the server 110 may exclude, based on the information of the traveling destination, a vehicle which is currently traveling toward the detected object but can be expected to deviate from the direction toward the detected object before arriving at the detected object, from transmission targets of the driving support information. Thus, the processing burden on the server 110 can be reduced.

In the above description, according to the positional relationship between each vehicle and a detected object, the server 110 selects, out of the hierarchized driving support information, a hierarchical layer to be transmitted, and transmits the hierarchical layer to the on-vehicle device of each vehicle. However, the present disclosure is not limited thereto. The server 110 may transmit all the hierarchical layers of the hierarchized driving support information to all the vehicles, and the on-vehicle device of each vehicle having received the same may select a hierarchical layer to be used for driving support, according to the positional relationship between the vehicle and the detected object. That is, the on-vehicle device may serve as an information providing device. In this case, the on-vehicle device includes: a reception unit that receives an analysis result from the server 110; a selection unit that selects a hierarchical layer from the received analysis result; and an output unit that outputs information of the selected hierarchical layer. The reception unit is implemented by the communication unit 146. The selection unit selects a hierarchical layer from the analysis result, according to the positional relationship between the vehicle (second dynamic object) and the detected object (first dynamic object). The selection unit is implemented by the control unit 150. In a specific example, the output unit displays the driving support information including the selected hierarchical layer such that the user can visually recognize the driving support information. That is, the on-vehicle device may include a display unit, and the output unit may be implemented by the display unit. In another example, the on-vehicle device is connected to a display device mounted on the vehicle. For example, the display device is connected to the I/F unit 144, receives an electric signal outputted from the I/F unit 144, and displays a screen including driving support information, according to the electric signal. In still another example, the output unit outputs the driving support information including the selected hierarchical layer, as speech that is audible to the user. That is, the on-vehicle device may include a loudspeaker, and the output unit may be implemented by the loudspeaker. In one example, the on-vehicle device is connected to the loudspeaker mounted on the vehicle. For example, the loudspeaker is connected to the I/F unit 144, receives an electric signal outputted from the I/F unit 144, and outputs speech including the driving support information, according to the electric signal. When an electric signal is outputted from the I/F unit 144 to the display device or the loudspeaker, the output unit is implemented by the I/F unit 144. Thus, the selection unit included in the on-vehicle device selects a predetermined hierarchical layer according to the positional relationship between the detected object and the vehicle on which the on-vehicle device is mounted, and the display device, the loudspeaker, or the like outputs information of the selected hierarchical layer.

The embodiments disclosed herein are merely illustrative and not restrictive in all aspects. The scope of the present disclosure is defined by the scope of the claims rather than the meaning described above, and is intended to include meaning equivalent to the scope of the claims and all modifications within the scope.

### REFERENCE SIGNS LIST

100 information providing system

102 infrastructure sensor

104 traffic signal unit

106 base station

108 network

110 server

112, 114, 116, 118, 220, 222, 224, 226, 226A, 226B, 226C, 226D vehicle

120, 150, 168 control unit

122, 148, 166 memory

124, 146, 164 communication unit

126, 152, 170 bus

140, 154 on-vehicle device

142, 198 sensor

144, 162 I/F unit

160 sensor unit

180 packet reception unit

182 packet transmission unit

184 data separation unit

186 analysis processing unit

188 vehicle specification unit

190 position specification unit

192 attribute specification unit

194 action specification unit

196 action prediction unit

200, 200A, 200B, 200C, 200D pedestrian

202, 204 traffic signal unit for pedestrians

206, 208, 210, 212 traffic signal unit for vehicles

230 message

240A, 240B, 240C, 240D graphic symbol

242, 244 predicted graphic symbol

I image sensor

R radar

L laser sensor

1. An information providing device comprising:
a selection unit configured to, according to a positional relationship between a first dynamic object and one or a plurality of second dynamic objects that receive information regarding the first dynamic object, select a hierarchical layer from an analysis result in which sensor information regarding the first dynamic object is hierarchized into a plurality of hierarchical layers; and
an output unit configured to output information of the hierarchical layer selected by the selection unit.

2. The information providing device according to claim 1, wherein
the analysis result is hierarchized in an ascending order of a delay time including a time from when the sensor information is transmitted from a sensor to when the sensor information is received by an analysis device, and a time during which the received sensor information is analyzed by the analysis device.

3. The information providing device according to claim 1, wherein the hierarchical layer includes at least one of position information, an attribute, an action, and action prediction of the first dynamic object.

4. The information providing device according to claim 1, wherein
the selection unit selects at least two hierarchical layers from among the plurality of hierarchical layers, and
the output unit outputs information of the selected hierarchical layers at the same timing to the second dynamic objects.

5. The information providing device according to claim 1, wherein
the selection unit selects at least two hierarchical layers from among the plurality of hierarchical layers, and
the output unit outputs information of the selected hierarchical layers at different timings to the second dynamic objects.

6. The information providing device according to claim 1, further including a determination unit configured to determine the positional relationship between the first dynamic object and the second dynamic object, according to at least one of heading, speed, acceleration, and destination of the second dynamic object.

7. The information providing device according to claim 1, wherein
the positional relationship is a distance between the first dynamic object and the second dynamic object.

8. The information providing device according to claim 1, wherein
the output unit outputs, to the second dynamic objects, information of the hierarchical layers, and update information indicating whether or not the information of the hierarchical layers has been updated.

9. The information providing device according to claim 1, wherein
there are a plurality of second dynamic objects, and the plurality of second dynamic objects are grouped according to a current position of each of the second dynamic objects, and
the output unit outputs information of the same hierarchical layer to the second dynamic objects in the same group.

10. (canceled)

11. (canceled)

12. An information providing system comprising:
a server computer including
a reception unit configured to receive sensor information, and
an analysis unit configured to analyze the sensor information received by the reception unit to detect a first dynamic object, and generate an analysis result in which the sensor information regarding the first dynamic object is hierarchized into a plurality of hierarchical layers; and
a communication device possessed by one or a plurality of second dynamic objects that receive information regarding the first dynamic object, wherein
the server computer further includes
a specification unit configured to specify a positional relationship between the first dynamic object and the second dynamic object,
a selection unit configured to select a hierarchical layer from among the plurality of hierarchical layers according to the positional relationship, and
a transmission unit configured to transmit information of the selected hierarchical layer to the communication device.

13. An information providing system comprising:
a server computer including
a reception unit configured to receive sensor information, and
an analysis unit configured to analyze the sensor information received by the reception unit to detect a first dynamic object, and generate an analysis result in which the sensor information regarding the first dynamic object is hierarchized into a plurality of hierarchical layers; and
a communication device possessed by one or a plurality of second dynamic objects that receive information regarding the first dynamic object, wherein
the server computer further includes a transmission unit configured to transmit information of the plurality of hierarchical layers to the second dynamic object, and
the communication device of the second dynamic object includes
a reception unit configured to receive the information of the plurality of hierarchical layers transmitted from the server computer,
a specification unit configured to specify a positional relationship between the first dynamic object and the second dynamic object,
a selection unit configured to select a hierarchical layer from among the plurality of hierarchical layers according to the positional relationship, and
an output unit configured to output information of the selected hierarchical layer.

14. A non-transitory computer readable storage medium storing data having a data structure which is hierarchized into a plurality of hierarchical layers regarding a dynamic object detected by analyzing sensor information, wherein
the plurality of hierarchical layers include:
a first hierarchical layer including information regarding a current position of the dynamic object;
a second hierarchical layer including information regarding a current attribute of the dynamic object;
a third hierarchical layer including information regarding a current action pattern of the dynamic object; and
a fourth hierarchical layer including information regarding at least one of a position, an attribute, and an action pattern of the dynamic object after a predetermined time.
